(19) United States
(12) Patent Application Publication
(10) Pub. No.: US 2016/0186428 A1
(43) Pub. Date: Jun. 30, 2016

(54) Heat Insulating Device

(71) Applicant: Jun CHEN, Jiangsu (CN)

(72) Inventor: Jun CHEN, Taicang (CN)

(21) Appl. No.: 14/786,547

(22) PCT Filed: Feb. 28, 2014
(86) PCT No.: PCT/CN2014/072671

§ 371 Date: Feb. 19, 2016

(30) Foreign Application Priority Data
Apr. 26, 2013 (CN) 201320218651.9

(51) Int. Cl. E04B 1/80; B32B 3/30; E04B 1/76

(52) U.S. Cl. CPC E04B 1/806; E04B 1/7612; B32B 3/30; B32B 2307/304; B32B 2419/00

(57) ABSTRACT

The present invention relates to a heat insulating device for a building, wherein a first insulating layer of the heat insulating device and a second insulating layer of the heat insulating device are coupled with each other. The first insulating layer and the second insulating layer define a plurality of first air chambers therebetween. The first air chambers are separated from each other by the second insulating layer to prevent a convection current generating between two neighboring first air chambers. The first air chambers are filled with air to reduce the heat exchange between the indoor heat and the outdoor heat.

### CROSS REFERENCE OF RELATED APPLICATION

This is a non provisional application that claims priority to international application number PCT/CN20111/072671, international filing date Feb. 28, 2014, the entire contents of each of which are expressly incorporated herein by reference.

### NOTICE OF COPYRIGHT

A portion of the disclosure of this patent document contains material which is subject to copyright protection. The copyright owner has no objection to any reproduction by anyone of the patent disclosure, as it appears in the United States Patent and Trademark Office patent files or records, but otherwise reserves all copyright rights whatsoever.

### BACKGROUND OF THE PRESENT INVENTION

1. Field of Invention

The present invention relates to a heat insulating device, and more particularly to a heat insulating device adapted for reducing heat exchange between indoor and outdoor. The present invention further relates to a heat insulating film.

2. Description of Related Arts

Buildings represent an important and increasing component of total energy consumption mix in most countries. In terms of primary energy consumption, buildings represent 40% of total final energy consumption. Officially, Chinese academics estimate that the buildings sector actually accounts for exceed 30% of total energy use in china. So various means for reducing heat exchange between indoor and outdoor are employed to minimize heat transfer. A common way to reduce the heat exchange is providing a thermal barrier coating for building. But the thermal barrier coating has a poor working life, for it is always exposed to air containing 21% oxygen. Besides, the temperature changes of environment make a contribution to destroying the thermal barrier coating. On the other hand, most of thermal barrier coatings are non-transparent, which brings about some negative influence on indoor daylighting.

IIcat insulating devices made of heat insulating material, for example a insulating layer or thermal film can be provided on outside of building to reduce heat exchange between the building and outdoor. But the heat insulating devices made of foam material are non- transparent, which have bad effects on indoor lighting. Most of the heat insulating devices made of heat-reflecting materials are expensive, and they not only reflect heat, but also light. The heat insulating devices made of vacuum insulation material are more expensive than the heat insulating devices made of heat-reflecting material.

Macromolecule membranes or polymer-membranes are another considerable choice for heat preservation in building. But most of the current heat insulating devices made of polymer material have a single-layer structure and only provide less good thermal results.

Moreover, the heat insulating devices, for example transparent membranes made of polymer, are also used in agriculture. Especially, they are used for agricultural greenhouses to permit light to pass through and reduce the heat exchange between the greenhouse and its circumstance.

Chinese Patent Publication Number 2481133Y teaches a heat insulating device comprising two plastic films, wherein the two plastic films are coupled each other to define an air chamber so as to define an air insulating wall between the building and its outdoor, wherein the air insulating wall can reduce the heat exchange between the building and its outdoor. But because the two plastic films are connected by heat seal, the air insulating wall is a whole and the convection currents can be produced within the air chamber such that when one of the two plastic films is broken in its local region, the whole air wall will be destroyed.

Most of existing heat insulating films for greenhouses only have a single layer structure, and these greenhouses made a single plastic layer have a poor insulation performance thereof. Especially, the disadvantage of the poor insulation performance becomes more obvious in winter. In order to solve this problem, people employ multiple technical solutions. Besides the conventional thermal method of covering a woven straw, some people design and manufacture a double-layer plastic film, as taught by Chinese utility model patent publication No. CN2481133Y, which consists of two layers of thin film, and the two thin film layers are fused together at partial portions thereof in a point welded manner or line welded manner to form an interconnected chamber. Because the double-layer plastic film taught by the utility model patent has a complex structure, a high cost production and a poor heat insulation performance.

A mulching film is also known as an agricultural film, which is generally used for covering a farmland to increase the temperature thereof in remote and alpine areas so as to ensure the farmland temperature promote seeds to germinate and young seedlings to grow. The mulching film can even be used for inhibiting the growth of weeds. Most of the existing mulching films employ straw material or a single layer of plastic film and have a poor insulation effect.

Relevant data from the National government departments shows that the energy shortage has been severe in china. Currently, the vast majority of existing residential buildings are high energy consumption buildings, and the energy consumption per unit area is equivalent to many times the energy consumption in developed countries. And the energy consumption of buildings accounts for more than one-third of the national's. The energy-saving of residential buildings is paid more and more attention in china, and the heat insulating film of the present invention can be as an inexpensive and effective indoor thermal material.

At present, people often use air conditionings to regulate indoor temperature, but the poor heat insulation effect of glass makes the air conditionings have high energy consumption. And there is no a heat insulating film which can be not only used as a heat insulating film for greenhouses and mulching films, but also as a heat insulating device provided on the wall and glass of a building.

### SUMMARY OF THE PRESENT INVENTION

The technical problem to be solved is to provide a heat insulating film, which is convenient to use, good in transparency and excellent in thermal insulation effect.

In order to solve the above technical problems, the present invention employs the following technical solutions;

a heat insulating film, comprising a planar bottom layer and a bubble-shaped layer having a side provided on the bottom layer, wherein the bubble-shaped layer comprises a plurality of connecting portions adhered to the bottom layer, a plurality of air chambers extended respectively from the connecting portions, wherein the heat insulating film further comprises a planar top layer provided on another side of the bubble-shaped layer, wherein the top layer is capable of defining a gap between every two neighboring chambers.

Specifically, the shape of the air chamber can be selected from the group consisting of cylindrical shape, hemispherical shape, conical shape, square shape, heart-shaped shape, rhombohedra-shaped shape and oval shape.

Specifically, at least one of the bottom layer and the top layer is printed with a pattern.

The present invention further provides an application that the heat insulating film is used for a greenhouse is provided.

The present invention further provide an application that the heat insulating film is used as a mulching film for covering a farmland is provided.

The present invention further provide an application that the heat insulating film is used for increasing heat insulating effect of glass is provided.

The specific usages are as follows: firstly, cleaning the glass, secondly cutting the heat insulating film according to the size of the glass; thirdly, wetting the glass, fourthly, pasting the cut heating insulating film on the wet glass without using any other adhesives, such as blue.

The present invention further provide an application that the heat insulating film is used for increasing the heat insulating effect of an inner wall of a house is provided.

Specifically, according to the method for manufacturing the heat insulating film, the mould for the heat insulating film has a plurality of grooves provided on a side thereof, wherein each of the grooves is communicated with a vacuum generator, when the heat insulating film is made, a plurality of air chambers are formed on the bottom layer under the negative pressure effect, which are respectively shaped and sized to match the grooves.

Beneficial effects of the present invention are as follows:

The heat insulating film of the present invention has a three-layer structure, and the middle bubble-shaped layer and the bottom layer define a plurality of sealed air chambers to support a air pad between the bottom layer and the top layer thereof, and the sealed air chambers and non-flowing dry air provided within the sealed air chambers is prevented from being convected with each other. At the same time, each of air and plastic layers has a low coefficient of heat conduction and can effectively prevent heat conduction so as to make heat conduction between airs (or other objects) having a temperature difference therebetween be prevented and inhibited, which are respectively distributed on the surfaces of the bottom layer and the top layer. Hence, the heat insulating film of the present invention has good heat insulation performance.

The heat insulating film of the present invention does not need additional adhesives and can be attached on the glass so just by spraying water on the glass. Hence, the heat insulating film of the present invention is easy to use.

The heat insulating film of the present invention mainly employs a technical solution for indoors warmth-keeping of buildings so as to reduce heat conduction between inside and outside of a residential building, which can play an important role in creating a convenient living environment and energy saving. The heat insulating film of the present invention can be used a new heating insulating material and has advantages of good economic returns, excellent thermal insulation effect, energy saving performance and ease of use and so on.

The invention is advantageous in that it provide a heat insulating device, wherein the heat insulating defines a non-convectable air wall adapted for being provided between a building and its environment to reduce the heat exchange between indoor and outdoor.

Another advantage of the invention is to provide a heat insulating device, wherein the heat insulating device comprises a first insulating layer and a second insulating layer, wherein the second insulating layer is provided on the first insulating layer, and the first insulating layer and the second insulating layer define a plurality of first air chambers therebetween to separate a building from its outdoor environment, wherein the first air chambers are filled with air and separated each other by the second insulating layer to reduce the air convection between the first air chambers and its outdoor environment so as to minimize the heat exchange between indoor and outdoor.

Another advantage of the invention is to provide a heat insulating device, wherein the heat insulating device further comprises a third insulating layer provided on the forming side of the second insulating layer, wherein the third insulating layer and the second insulating layer define a plurality of second air chambers therebetween, wherein the second air chambers are filled with air and communicated each other such that the first air chambers and the second air chambers define an air insulating wall for separate a building and outdoor thereof to reduce the heat exchange between indoor and outdoor.

Another advantage of the invention is to provide a heat insulating device, wherein the air insulating wall comprises the first air chamber and the second air chambers such that when the heat insulating device is broken in its local region, the whole air insulating wall will not be destroyed.

Another advantage of the invention is to provide a heat insulating device, wherein each of the first air chambers has a parallelogram shape and is regularly arranged between the first insulating layer and the second insulating layer to minimize the size of the second air chamber.

Additional advantages and features of the invention will become apparent from the description which follows, and may be realized by means of the instrumentalities and combinations particular point out in the appended claims.

According to the present invention, the foregoing and other objects and advantages are attained by a heat insulating device, wherein the heat insulating device comprises a first insulating layer and a second insulating layer, wherein the second insulating layer is provided on the first insulating layer, wherein the first insulating layer and the second insulating layer define a plurality of first air chamber therebetween, wherein each of the first air chamber is filled with air.

The heat insulating device further comprises a third insulating layer, wherein the third insulating layer and the second insulating layer define a plurality of second air chambers therebetween, wherein the second air chambers are filled with air and communicated each other such that the first air chambers and the second air chambers define an air insulating wall for separate a building and outdoor thereof to reduce the heat exchange between indoor and outdoor.

Still further objects and advantages will become apparent from a consideration of the ensuing description and drawings.

These and other objectives, features, and advantages of the present invention will become apparent from the following detailed description, the accompanying drawings, and the appended claims.

### BRIEF DESCRIPTION OF THE DRAWINGS

FIG. 1 is a plant view of a heat insulating device according to a first preferred embodiment of the present invention.

FIG. 2 is a schematic diagram from a top side of the heat insulating device according to the above first preferred embodiment of the present invention.

FIG. 3 is a sectional view of the heat insulating device according to the above first preferred embodiment of the present invention.

FIG. 4 illustrates the first air chambers are arranged between the first insulating layer and the second insulating layer of the heat insulating device according to the above first preferred embodiment of the present invention.

FIG. 5 illustrates the second air chambers are provided between the third insulating layer and the second insulating layer of the heat insulating device according to the above first preferred embodiment of the present invention.

FIG. 6 is a plant view of a heat insulating device according to a second preferred embodiment of the present invention.

FIG. 7 is a sectional view of a heat insulating device according to the above second preferred embodiment of the present invention.

FIG. 8 is a sectional view of a heat insulating device according to the above second preferred embodiment of the present invention.

FIG. 9 is a sectional view of a heat insulating device according to the above second preferred embodiment of the present invention.

FIG. 10 is a flow diagram of a manufacturing method for the heat insulating device according to the above first preferred embodiment of the present invention.

FIG. 11 is a flow diagram of a manufacturing method for the heat insulating device according to the above second preferred embodiment of the present invention.

FIG. 12A is a perspective view of the heat insulating film according to the third preferred embodiment of the present invention.

FIG. 12B is a sectional view of the heat insulating film according to the above third preferred embodiment of the present invention.

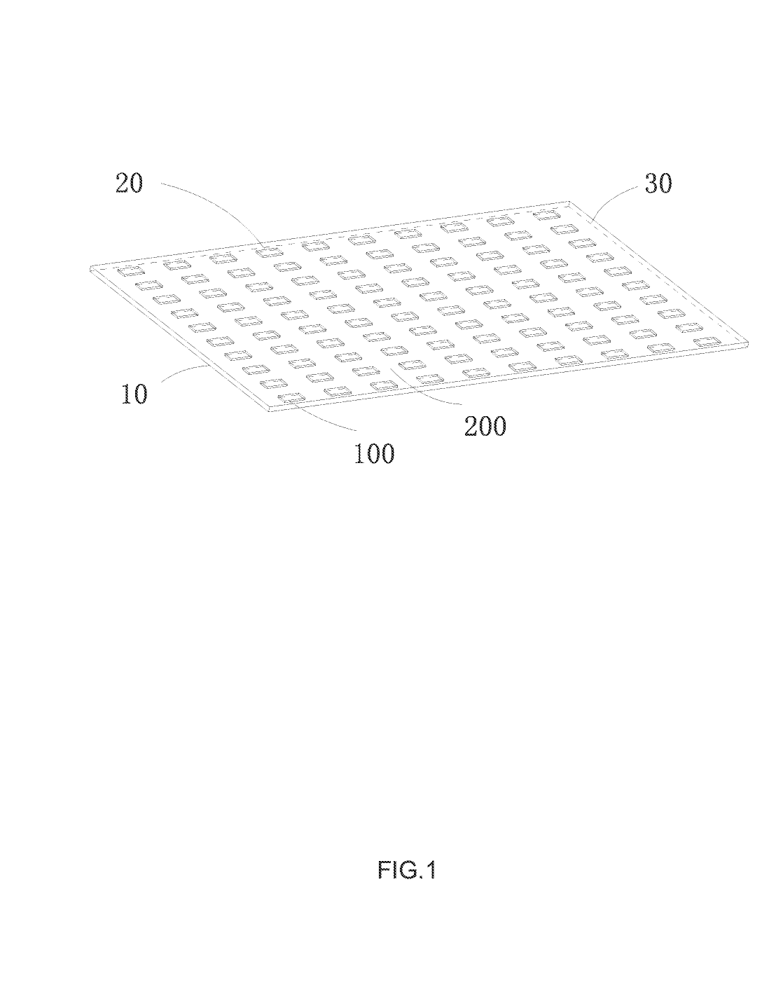

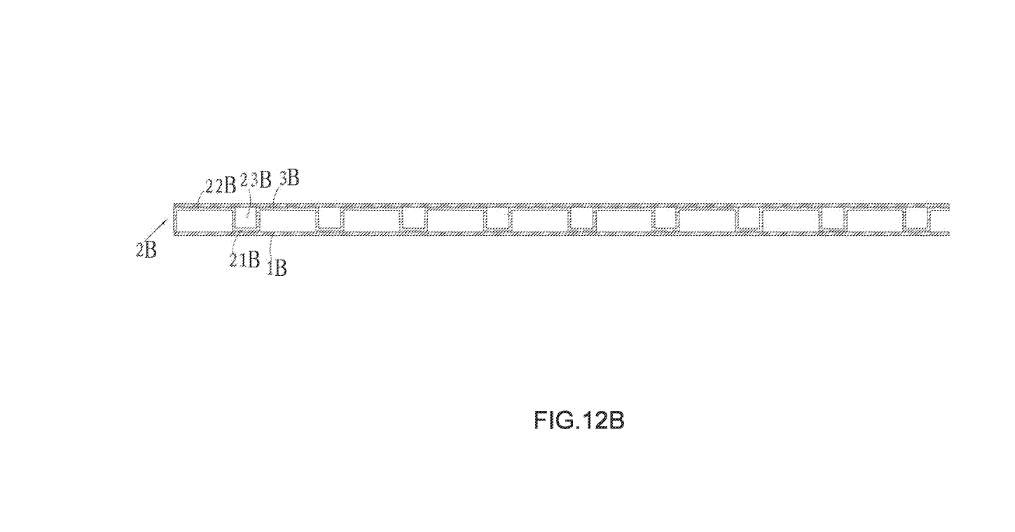

In the above FIGS. 12A and 12B, 1B: bottom layer, 2B: bubble-shaped layer, 3B: top layer, 21B: connecting portion, 22B: air chamber, 23B: gap.

### DETAILED DESCRIPTION OF THE PREFERRED EMBODIMENT

The following description is disclosed to enable any person skilled in the art to make and use the present invention. Preferred embodiments are provided in the following description only as examples and modifications will be apparent to those skilled in the art. The general principles defined in the following description would be applied to other embodiments, alternatives, modifications, equivalents, and applications without departing from the spirit and scope of the present invention.

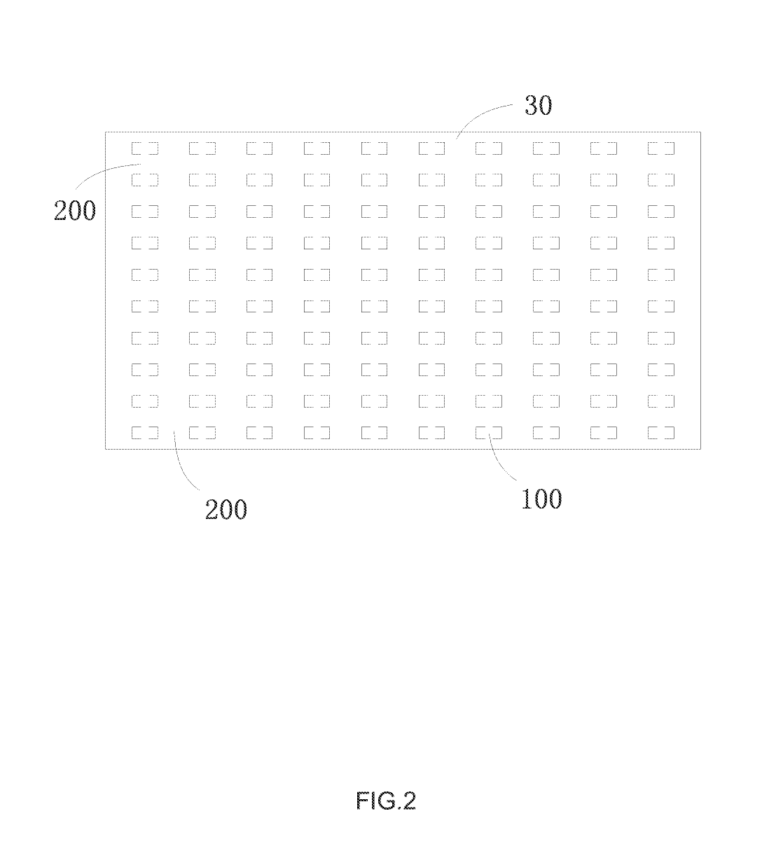

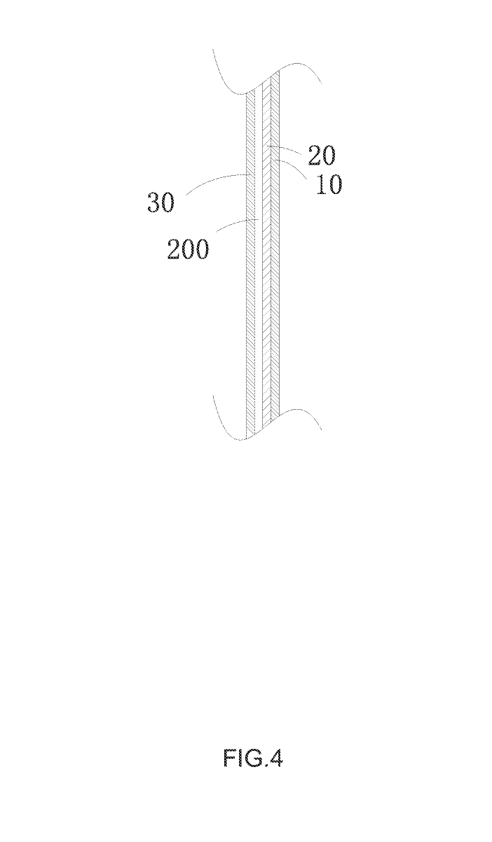

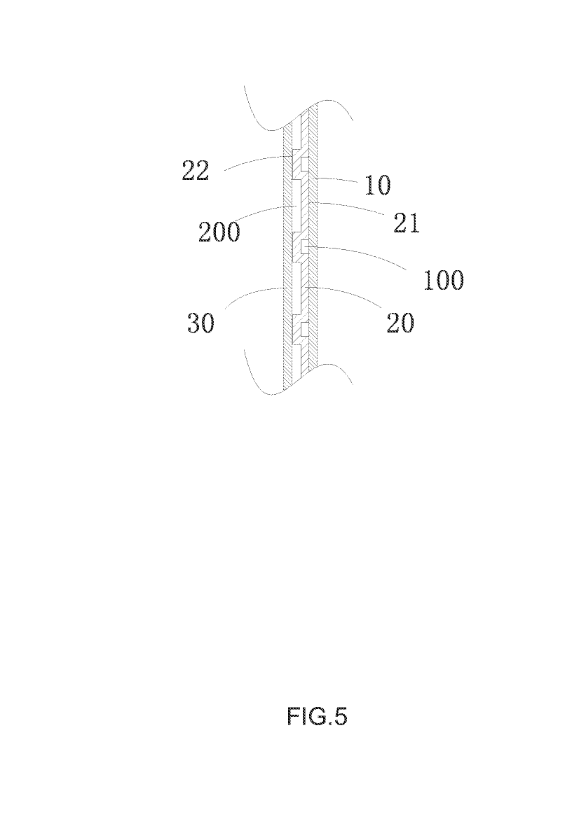

Referring to FIG. 1 to FIG. 5 of the drawings, a heat insulating device according to the first preferred embodiment or the present invention is illustrated. According to the first preferred embodiment, the heat insulating device comprises a first insulating layer 10 and a second insulating layer 20 coupled with the first insulating layer 10, wherein the first insulating layer 10 and the second insulating layer 20 define a plurality of first air chambers 100 therebetween, wherein the first air chambers 100 are filled with air to prevent the air convection between the first air chamber 100 and outdoor environment of the building so as to minimize the heat exchange between indoor and outdoor thereof. Preferably, the first air chambers 100 are separated each other by the second insulating layer 20 to prevent a convection current generating between two neighboring first air chambers 100.

As shown in FIG. 1 to FIG. 3 of the drawings, the heat insulating device further comprises a third insulating layer 30, wherein the second layer 20 is sandwiched between the first insulating layer 10 and the third insulating layer 30 such that the second insulating layer 20 and the third insulating layer 30 define a plurality of second air chambers 200 therebetween, wherein the second air chambers 200 are communicated with each other. Preferably, each of the second air chambers 200 is filled with air.

It is worth mentioning that the first air chambers 100 and the second air chambers 200 define an air insulating wall to separate the building from the environment thereof to reduce the heat exchange between indoor and outdoor. In other words, the air insulating wall comprises a plurality of the first air chambers 100 which are separated from each other such that when the heat insulating device is broken in its local region, the air insulating wall will not be entirely destroyed.

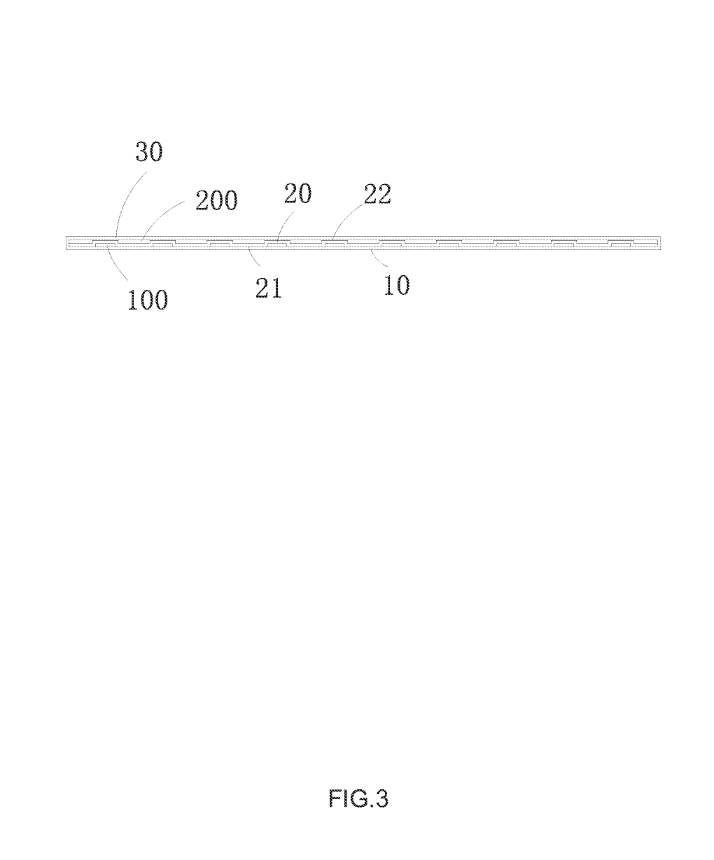

As shown in FIG. 3 to FIG. 5 of the drawings, the second insulating layer 20 has a first side 21 and a second side 22, wherein the first side 21 of the second insulating layer 20 is integrally provided on the first insulating layer 10, and the second side 22 is integrally provided on the third insulating layer 30. Preferably, the first insulating layer 10 is adapted to be provided on an external surface of a building.

As shown in FIG. 3 to FIG. 5 of the drawings, each of the first air chamber 100 has a parallelogram-shaped horizontal section, and the first air chambers 100 are respectively and regularly arranged between the first insulating layer 10 and the second insulating layer 20 to minimize the size of the second air chamber 200. Preferably, the first air chamber 100 has a rectangle-shaped horizontal section. More preferably, the first air chamber 100 has a square-shaped horizontal section. However, those skilled in the art will appreciate that the first air chambers 100 may be of any shape. Most preferably, each of the second air chambers 200 is 0.5 mm-5 mm in length. In other words, the distance between two neighboring first chambers is 0.5 mm-5 mm.

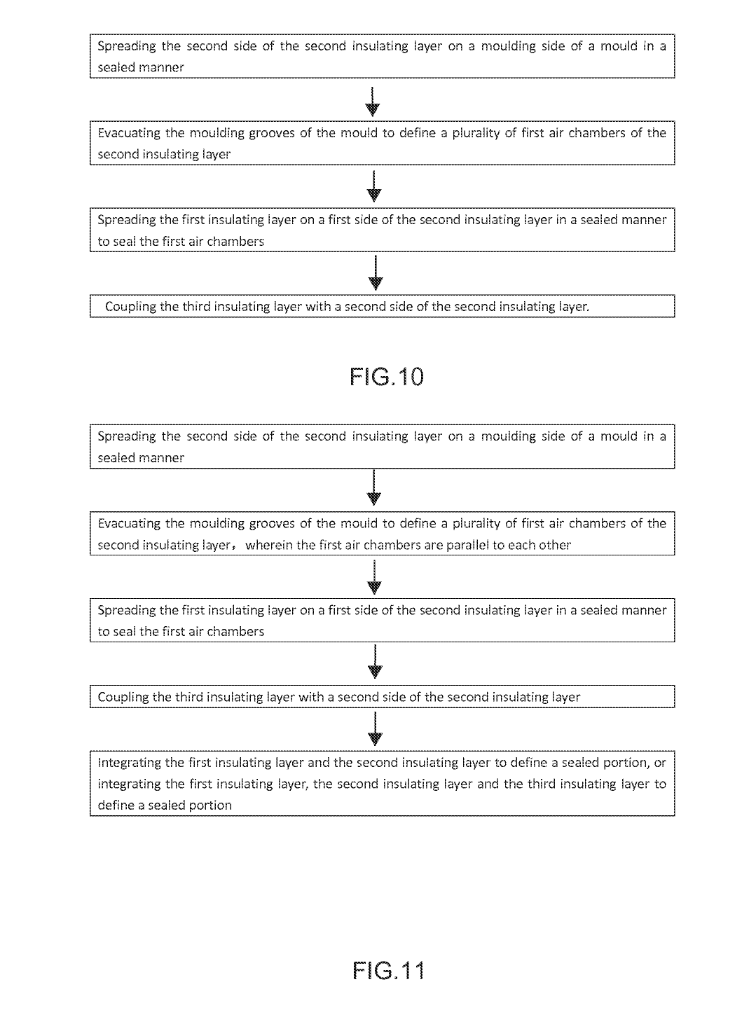

As shown in FIG. 10 of the drawings, the present invention further provides a manufacturing method for a heat insulating device, comprising the following steps:

(1) spreading the second side 22 of the second insulating layer 20 on a moulding side of a mould in a sealed manner, wherein a plurality of moulding grooves are arranged in the mould, wherein each of the moulding grooves is downwardly extended form the moulding side;

(2) evacuating the moulding grooves of the mould to define a plurality of first air chambers 100 of the second insulating layer 20; and

(3) spreading the first insulating layer 10 on the first side 21 of the second insulating layer 20 in a sealed manner to seal the first air chambers 100.

Preferably, the manufacturing method further comprise the following step:

(4) coupling the third insulating layer 30 with the second side 22 of the second insulating layer 20.

More preferably, the moulding grooves are separated from each other to make the first air chambers of the second insulating layer 20 define a plurality of isolated chambers. Most preferably, the distance between two neighboring moulding grooves is 0 5 mm-5 mm.

It is worth mentioning that the second insulating layer 20 is made of thermoplastic material, and the first insulating layer 10 and the third insulating layer 30 are both made of thermoplastic material. Preferably, the second insulating layer 20 is made of amorphous thermoplastic material, and the first insulating layer 10 and the third insulating layer 30 are both made of amorphous thermoplastic material. Alternatively, the first insulating layer 10 and/or the third insulating layer 30 are made of reflective material.

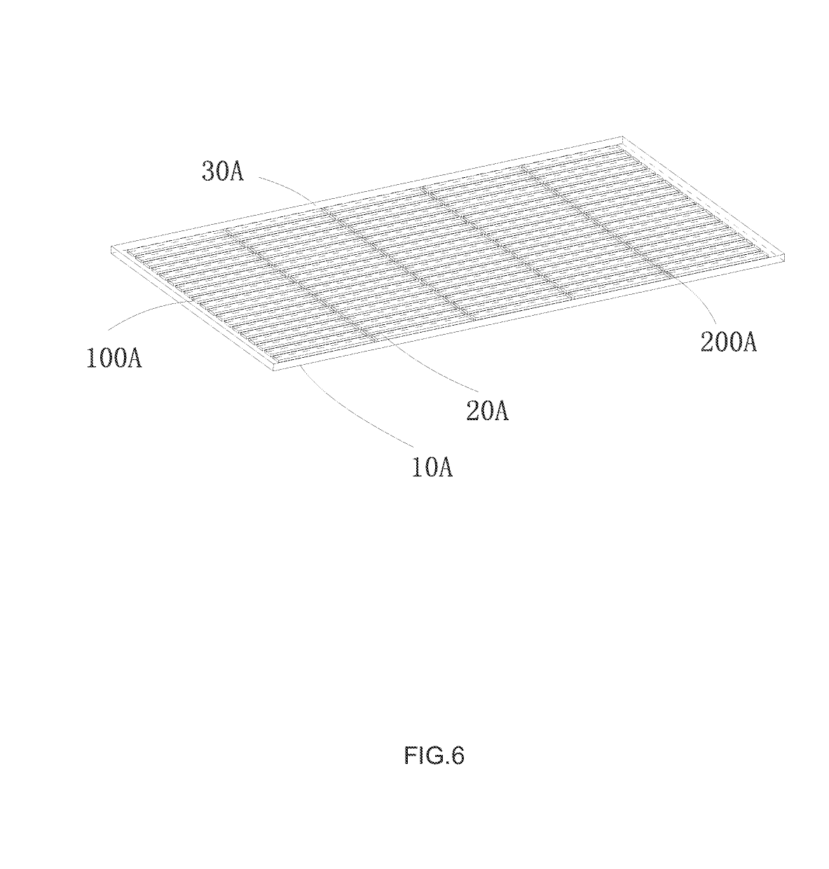

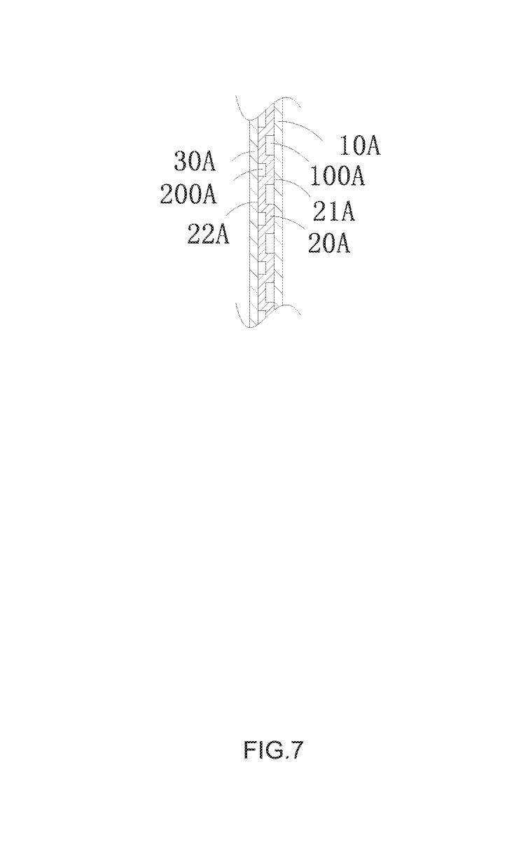

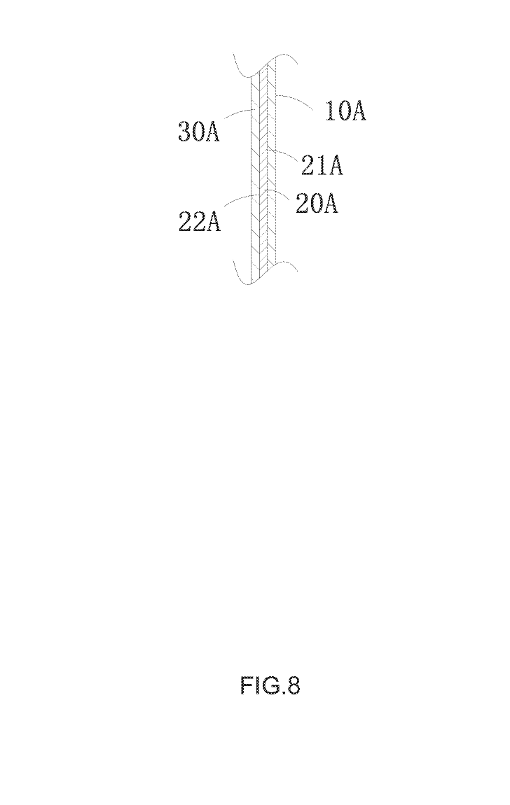

Referring to FIG. 6 to FIG. 9 of the drawings, a heat insulating device according to the second preferred embodiment of the present invention is illustrated. According to the second preferred embodiment, the heat insulating device comprises a first insulating layer 10 A, a second insulating layer 20A and a third insulating layer 30A, wherein the second insulating layer 20A is integrally provided between the first insulating layer 10A and the third insulating layer 30A, wherein the first insulating layer 10A and the second insulating layer 20A define a plurality of first air chambers 100A therebetween, and the second insulating layer 20A and the third insulating layer 30A define a plurality of second of chambers 200A, wherein each of the second air chambers 200A is arranged between every two neighboring first air chambers 100A, wherein each of the second air chambers 200A is parallel with the first air chambers 100A, and the first air chambers 100A are parallel with each other. Preferably, each of the first air chambers 100A is filled with air and sealed to define an isolated air chamber to prevent a convection current generating between the isolated air chamber and a neighboring first air chamber 100A or second air chamber 200A. More preferably, each of the second air chambers 200A is filled with air and sealed to define a separated air chamber to prevent a convection current generating between the separated air chamber and a neighboring first air chamber 100A or second air chamber 200A.

As shown in FIG. 6 to FIG. 9 of the drawings, the heat insulating device further comprises a plurality of sealing portions 40, wherein the first insulating layer 10A, the second insulating layer 20A and the third insulating layer 30A are tightly and sealedly integrated together in a sealing portion such that all isolated air chamber and a separated air chamber is defined between two neighboring sealing portion 40A.

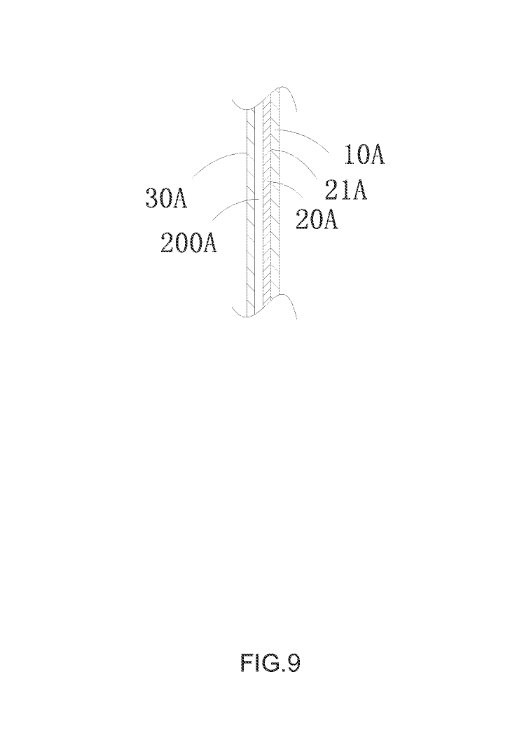

As shown in FIG. 9 of the drawings, each of the first air chamber 100A has a parallelogram-shaped horizontal section, and the first air chambers 100A are respectively and regularly arranged between the first insulating layer 10A and the third insulating layer 30A.

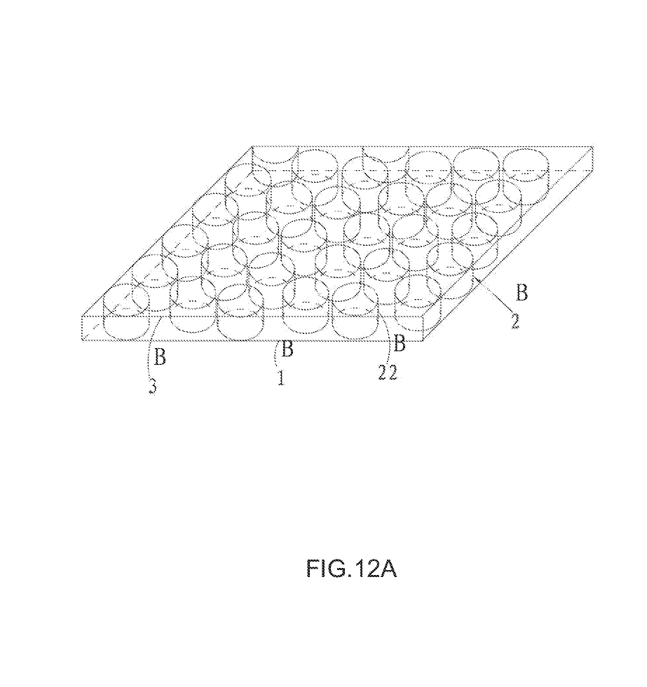

As shown in FIG. 11 of the drawings, the present invention further provides another manufacturing method for a heat insulating device, comprising the following is steps:

(1) spreading the second side 22A of the second insulating layer 20A on a moulding side of a mould in a sealed manner, wherein a plurality of moulding grooves are arranged in the mould, wherein each of the moulding grooves is downwardly extended form the moulding side;

(2) evacuating the moulding grooves of the mould to define a plurality of first air chambers 100A of the second insulating layer 20A, wherein the first air chambers 100A are parallel to each other; and

(3) spreading the first insulating layer 10A on a first side 21A of the second insulating layer 20A in a sealed manner to seal the first air chambers 100A.

Preferably, the manufacturing method further comprise the following step:

(4) coupling the third insulating layer 30A with a second side 22A of the second insulating layer 20A.

More preferably, the manufacturing method further comprise the following step:

(5) integrating the first insulating layer 10A and the second insulating layer 20A to define a sealed portion 40A, of integrating the first insulating layer 10A, the second insulating layer 20A and the third insulating layer 30A to define a scaled portion 40A.

It is worth mentioning that the integrating method may be a heat-sealing method, a mechanical force pressing method or an adhesive binding method or combination thereof to sealing hermetically the first insulating layer 10A, the second insulating layer 20A and the third insulating layer 30A to define a sealed portion 40A.

Referring to FIG. 12A to FIG. 12B of the drawings, a heat insulating film according to the thud preferred embodiment of the present invention is illustrated. According to the third preferred embodiment, the heat insulating film comprises a planar bottom layer 1B and a bubble-shaped layer 2B having a side provided on the bottom layer 1B, wherein the bubble-shaped layer 2B comprises a plurality of connecting portions 21B adhered to the bottom layer 1B, a plurality of air chambers 22B extended respectively from the connecting portions 21B, wherein each of the air chambers 22B is a sealed space fulfilled with air, wherein the heat insulating film further comprises a planar top layer 3B provided on another side of the bubble-shaped layer 2B, wherein the top layer 3B is capable of defining a gap 23B between every two neighboring chambers, and the gaps 23B and the top layer 3B define an air pad therebetween. Each of the air chambers 22B has a shape selected from the group consisting of cylindrical shape, hemispherical shape, conical shape, square shape, heart-shaped shape, rhombohedra-shaped shape and oval shape, or selected from other shapes.

At least one of the bottom layer 1B and the top layer 2B is printed with a pattern, when the heat insulating film is attached on the glass or an inner wall of a building.

The present invention further provides an application of the heat insulating film, which is used for a greenhouse.

The present invention further provides an application of the heal insulating film, which is used as a mulching film for covering a farmland.

The present invention further provides an application of the heat insulating film, which is used for increasing heat insulating effect of glass.

The present invention further provides an application of the heat insulating film, which is used for increasing the heat insulating effect of an inner wall of a house.

The present invention further provides an application of the heat insulating film, which is used for increasing the heat insulating effect of an inner wall of a house.

The specific usages are as follows: firstly, cleaning the glass, secondly cutting the heat insulating film according to the size of the glass; thirdly, wetting the glass, fourthly, pasting the cut heating insulating film on the wet glass. The heating insulating film of the present invention can provide an air pad provided on the surface of the glass so as to provide a good thermal effect. In summer, the heating insulating film of the present invention may reduce the indoor temperature by at least 3° C.; in winter, the heating insulating film of the present invention may increase the indoor temperature by at least 3° C. Furthermore, the heating insulating film of the present invention has a good light transmittance performance, therefore even if the glass is provided with the heating insulating film of the present invention, sunlight can still easily strike into the room, so the indoor lighting will not be affected.

The above described embodiments is only for illustrating the technical principles of the present invention so as to enable any person skilled in the art to understand and implement the present invention, which is not intended to limit the scope of the present invention. All of equivalents and modifications without departing from the spirit and scope of the present invention should be within the protection scope of the present invention.

One skilled in the art will understand that the embodiment of the present invention as shown in the drawings and described above is exemplary only and not intended to be limiting.

It will thus be seen that the objects of the present invention have been fully and effectively accomplished. The embodiments have been shown and described for the purposes of illustrating the functional and structural principles of the present invention and is subject to change without departure from such principles. Therefore, this invention includes all modifications encompassed within the spirit and scope of the following claims.

1. A heat insulating device for a building, comprising:
a first insulating layer and a second insulating layer coupled with said first insulating layer, wherein said first insulating layer and said second insulating layer define a plurality of first air chambers therebetween, wherein said first air chambers are separated from each other by said second insulating layer to prevent a convection current generating between two neighboring first air chambers, wherein said first air chambers are filled with air to reduce the heat exchange between indoor and outdoor.

2. The heat insulating device, as recited in claim 1, further comprising a third insulating layer, wherein said second layer is sandwiched between said first insulating layer and said third insulating layer such that said second insulating layer and said third insulating layer define a plurality of second air chambers therebetween, wherein said second air chambers are communicated with each other, wherein each of said second air chambers is filled with air to reduce said heat exchange between indoor and outdoor.

3. The heat insulating device, as recited in claim 2, wherein said first air chambers and said second air chambers define an air insulating wall to separate said building from said environment thereof to reduce said heat exchange between indoor and outdoor.

4. The heat insulating device, as recited in claim 3, wherein said second insulating layer has a first side and a second side, wherein said first side of said second insulating layer is integrally provided on said first insulating layer, and said second side is integrally provided on said third insulating layer.

5. The heat insulating device, as recited in claim 2, wherein each of said first air chamber has a parallelogram-shaped horizontal section, and said first air chambers are respectively and regularly arranged between said first insulating layer and said second insulating layer to minimize said size of said second air chamber.

6. The heat insulating device, as recited in claim 4, wherein each of said first air chamber has a parallelogram-shaped horizontal section, and said first air chambers are respectively and regularly arranged between said first insulating layer and said second insulating layer to minimize said size of said second air chamber.

7. The heat insulating device, as recited in claim 6, wherein said first air chamber has a rectangle-shaped horizontal section.

8. The heat insulating device, as recited in claim 1, wherein the distance between two neighboring first chambers is 0.5 mm-5 mm.

9. The heat insulating device, as recited in claim 7, wherein the distance between two neighboring first chambers is 0.5 mm-5 mm.

10. The heat insulating device, as recited in claim 2, wherein said second insulating layer is made of thermoplastic material, and said first insulating layer and said third insulating layer are both made of thermoplastic material.

11. The heat insulating device, as recited in claim 9, wherein said second insulating layer is made of thermoplastic material, and said first insulating layer and said third insulating layer are both made of thermoplastic material.

12. The heat insulating device, as recited in claim 11, wherein said second insulating layer is made of amorphous thermoplastic material, and said first insulating layer and said third insulating layer are both made of amorphous thermoplastic material.

13. The heat insulating device, as recited in claim 2, wherein said first insulating layer and said third insulating layer are made of reflective materials.

14. A heat insulating device for a building, comprising:
a first insulating layer, a second insulating layer and a third insulating layer, wherein said second insulating layer is integrally provided between said first insulating layer and said third insulating layer, wherein said first insulating layer and said second insulating layer define a plurality of first air chambers therebetween, and said second insulating layer and said third insulating layer define a plurality of second of chambers, wherein each of said second air chambers is arranged between every two neighboring first air chambers, wherein each of said second air chambers is parallel with said first air chambers, and said first air chambers are parallel with each other.

15. The heat insulating device, as recited in claim 14, wherein each of said first air chambers is filled with air and sealed to define an isolated air chamber to prevent a convection current generating between said isolated air chamber and a neighboring first air chamber or second air chamber, and each of said second air chambers is filled with air and sealed to define a separated air chamber to prevent a convection current generating between said separated air chamber and a neighboring first air chamber or second air chamber.

16. The heat insulating device, as recited in claim 15, wherein said heat insulating device further comprises a plurality of sealing portions, wherein said first insulating layer, said second insulating layer and said third insulating layer are tightly and sealedly integrated together in said sealing portion such that an isolated air chamber and a separated air chamber are defined between two neighboring sealing portion.

17. The heat insulating device, as recited in claim 14, wherein each of said first air chamber has a parallelogram-shaped horizontal section, and said first air chambers are respectively and regularly arranged between said first insulating layer and said third insulating layer.

18. The heat insulating device, as recited in claim 16, wherein each of said first all chamber has a parallelogram-shaped horizontal section, and said first air chambers are respectively and regularly arranged between said first insulating layer and said third insulating layer.

19-20. (canceled)

21. A heat insulating film, comprising a planar bottom layer and a bubble-shaped layer having a side, where the side of the bubble-shaped layer is adhered on the bottom layer, wherein the bubble-shaped layer comprises a plurality of connecting portions adhered to the bottom layer, a plurality of air chambers extended respectively from the connecting portions, wherein the heat insulating film further comprises a planar top layer adhered on another side of the bubble-shaped layer, wherein the top layer is capable of covering a gap between every two neighboring chambers.

22. (canceled)

23. The heat insulating film, as recited in claim 21, wherein at least one of the bottom layer and the top layer is printed with a pattern.

24-27. (cancelled)
